(19) United States
(12) Patent Application Publication
(10) Pub. No.: US 2025/0158726 A1
(43) Pub. Date: May 15, 2025

(54) ENHANCED REFERENCE SIGNAL PREDICTION IN TELECOMMUNICATION SYSTEMS

(71) Applicant: Nokia Technologies Oy, Espoo (FI)

(72) Inventors: Matha DEGHEL, Massy (FR); Keeth Saliya Jayasinghe LADDU, Espoo (FI); Mihai ENESCU, Espoo (FI)

(21) Appl. No.: 18/841,797

(22) PCT Filed: Jan. 20, 2023
(86) PCT No.: PCT/EP2023/051433

§ 371 Date: Aug. 27, 2024

(30) Foreign Application Priority Data
Apr. 28, 2022 (FI) 20225362

(51) Int. Cl. H04B 17/391; H04B 7/06; H04L 5/00

(52) U.S. Cl. CPC H04B 17/3913; H04B 7/06952; H04L 5/0051

(57) ABSTRACT

Various example embodiments relate to a solution for enhanced reference signal prediction. A user device may be configured to perform both a reference signal measurement and reference signal prediction for at least one time instance for validating the reference signal prediction.

### TECHNICAL FIELD

Various example embodiments generally relate to the field of telecommunication systems. In particular, some example embodiments relate to a solution for enhanced reference signal prediction in telecommunication systems.

### BACKGROUND

In modern wireless communication networks, in downlink beam management, measurements are performed by user equipment (UE) on signals, for example, synchronization signal block (SSB) or channel state information reference signal (CSI-RS) transmitted by a base station, for example, a gNB. Information regarding which beam the UE has selected may be conveyed to the gNB by reporting an index to the corresponding SSB or CSI-RS resource. The UE may be configured by the network to report a number of strongest beams. The reporting configuration for the beam management is part of the CSI reporting configuration, meaning that the UE should be configured with uplink (UL) resources to enable the reporting.

One possibility for improving the conventional solution may be to apply beam prediction, for example, by using neural network (NN) solutions based on a neural network algorithm placed at either or both ends of the communication (for example, UE and gNB). For example, the gNB may learn the medium between the UE and gNB and construct a NN model/parametrization which is transferred to the UE. Once the NN model is constructed, a traditional type of radio signalling may happen between the gNB and UE, similar to what is currently specified in, for example, 5G, Long-Term Evolution (LTE) etc.

One challenge with the existing solutions is the amount of overhead making the solutions inefficient.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that may enable reference signal prediction adaptation in time. This benefit may be achieved by the features of the independent claims. Further implementation forms are provided in the dependent claims, the description, and the drawings.

According to a first aspect, a user device may comprise at least one processor and at least one memory including computer program code. The at least one memory and the computer program code are configured to, with the at least one processor, cause the user device at least to perform both a reference signal measurement and reference signal prediction for at least one time instance for validating the reference signal prediction.

In an example embodiment of the first aspect, the at least one memory and the computer program code are configured to, with the at least one processor, cause the user device at least to receive, from a network device, an indication to perform both the reference signal measurement and reference signal prediction for the at least one time instance.

In an example embodiment of the first aspect, the at least one memory and the computer program code are configured to, with the at least one processor, cause the user device at least to apply an implicit determination of at least one time instance for which both the reference signal measurement and reference signal prediction is performed, when failing to receive an indication to perform both the reference signal measurement and reference signal prediction for the at least one time instance from a network device. In an example embodiment of the first aspect, the at least one memory and the computer program code are configured to, with the at least one processor, cause the user device at least to determine that there is a success of reference signal prediction for the at least one time instance; and transmit to the network device a success indication of the reference signal prediction for the at least one time instance.

In an example embodiment of the first aspect, the at least one memory and the computer program code are configured to, with the at least one processor, cause the user device at least to receive, from the network device, an indication to perform reference signal prediction for the at least one time instance and stop measuring the reference signal for the at least one time instance; and perform reference signal prediction for the at least one time instance and stop measuring the reference signal for the at least one time instance.

In an example embodiment of the first aspect, the at least one memory and the computer program code are configured to, with the at least one processor, cause the user device at least to receive, from the network device, an indication to perform both reference signal measurement and reference signal prediction for at least one second time instance; and perform both reference signal measurement and reference signal prediction for at least one second time instance.

In an example embodiment of the first aspect, the at least one memory and the computer program code are configured to, with the at least one processor, cause the user device at least to receive, from the network device, an indication to change the number of time instances that are only predicted, the number of time instances that are only measured and/or the number of time instances that are predicted and measured; and perform reference signal prediction only for the changed the number of time instances that are only predicted and/or reference signal measurements only for the changed the number of time instances that are only measured.

In an example embodiment of the first aspect, the at least one memory and the computer program code are configured to, with the at least one processor, cause the user device at least to determine that there is a failure of reference signal prediction for the at least one time instance; and transmit to the network device a failure indication of the reference signal prediction for the at least one time instance.

In an example embodiment of the first aspect, the at least one memory and the computer program code are configured to, with the at least one processor, cause the user device at least to receive, from the network device, an indication to maintain performing reference signal prediction for the at least one time instance; and perform reference signal prediction according to the indication.

In an example embodiment of the first aspect, the at least one memory and the computer program code are configured to, with the at least one processor, cause the user device at least to receive, from the network device, an indication to change the number of time instances that are only predicted, the number of time instances that are only measured and/or the number of time instances that are predicted and measured; and perform reference signal measurements and/or reference signal prediction according to the indication.

In an example embodiment of the first aspect, the at least one memory and the computer program code are configured to, with the at least one processor, cause the user device at least to receive, from a network device, an indication to report the number of measured time instances, the number of predicted time instances, and/or the number of measured and predicted time instances.

In an example embodiment of the first aspect, the at least one memory and the computer program code are configured to, with the at least one processor, cause the user device at least to determine assistance information for updating the number of measured time instances, the number of predicted time instances, and/or the number of measured and predicted time instances; transmit, to the network device, the assistance information for updating the number of measured time instances, the number of predicted time instances, and/or the number of measured and predicted time instances; and apply the assistance information in performing reference signal measurements and/or reference signal prediction for the at least one time instance.

In an example embodiment of the first aspect, the at least one memory and the computer program code are configured to, with the at least one processor, cause the user device at least to determine assistance information for updating the number of measured time instances, the number of predicted time instances, and/or the number of measured and predicted time instances; transmit, to the network device, the assistance information for updating the number of measured time instances, the number of predicted time instances, and/or the number of measured and predicted time instances; receive, from the network device, a confirmation to apply the assistance information in performing reference signal measurements and/or reference signal prediction for the at least one time instance; and apply the assistance information in performing reference signal measurements and/or reference signal prediction for the at least one time instance.

In an example embodiment of the first aspect, the at least one memory and the computer program code are configured to, with the at least one processor, cause the user device at least to determine assistance information for updating the number of time the number of predicted time measured instances, instances, and/or the number of measured and predicted time instances; and transmit, to the network device, the assistance information for updating the number of measured time instances, the number of predicted time instances, and/or the number of measured and predicted time instances; receive, from the network device, an indication to use a network device updated number of measured time instances, number of predicted time instances, and/or number of measured and predicted time instances; and apply the network device updated number of measured time instances, number of predicted time instances, and/or number of measured and predicted time instances.

According to a second aspect, a network device may comprise at least one processor and at least one memory including computer program code. The at least one memory and the computer program code are configured to, with the at least one processor, cause the network device at least to transmit an indication to a user device to perform both a reference signal measurement and reference signal prediction for at least one time instance for validating the reference signal prediction.

In an example embodiment of the second aspect, the at least one memory and the computer program code are configured to, with the at least one processor, cause the network device at least to transmit an indication to the user device to evaluate whether there is a success or failure of the reference signal prediction for the at least one time instance.

In an example embodiment of the second aspect, the at least one memory and the computer program code are configured to, with the at least one processor, cause the network device at least to receive, from the user device, a success indication of the reference signal prediction for the at least one time instance; determine, based on the success indication, to perform reference signal prediction for the at least one time instance and stop measuring the reference signal for the at least one time instance; and transmit an indication to the user device to perform reference signal prediction for the at least one time instance and stop measuring the reference signal for the at least one time instance.

In an example embodiment of the second aspect, the at least one memory and the computer program code are configured to, with the at least one processor, cause the network device at least to receive, from the user device, a success indication of the reference signal prediction for the at least one time instance; determine, based on the success indication, to perform both reference signal measurement and reference signal prediction for at least one second time instance; and transmit an indication to the user device to perform both reference signal measurement and reference signal prediction for at least one second time instance.

In an example embodiment of the second aspect, the at least one memory and the computer program code are configured to, with the at least one processor, cause the network device at least to receive, from the user device, a success indication of the reference signal prediction for the at least one time instance; determine, based on the success indication, to change the number of time instances that are only predicted, the number of time instances that are only measured and/or the number of time instances that are predicted and measured; and transmit an indication to the user device to change the number of time instances that are only predicted and/or change the number of time instances that are only measured.

In an example embodiment of the second aspect, the at least one memory and the computer program code are configured to, with the at least one processor, cause the network device at least to receive, from the user device, a failure indication of the reference signal prediction for the at least one time instance; determine, based on the failure indication, to maintain performing reference signal prediction for the at least one time instance; and transmit an indication to the user device to maintain performing reference signal prediction for the at least one time instance.

In an example embodiment of the second aspect, the at least one memory and the computer program code are configured to, with the at least one processor, cause the network device at least to receive, from the user device, a failure indication of the reference signal prediction for the at least one time instance; determine, based on the failure indication, to change the number of time instances that are only predicted, the number of time instances that are only measured and/or the number of time instances that are predicted and measured; and transmit an indication to the user device to change the number of time instances that are only predicted and/or change the number of time instances that are only measured.

In an example embodiment of the second aspect, the at least one memory and the computer program code are configured to, with the at least one processor, cause the network device at least to transmit an indication to the user device to report the number of measured time instances, the number of predicted time instances, and/or the number of measured and predicted time instances.

In an example embodiment of the second aspect, the at least one memory and the computer program code are configured to, with the at least one processor, cause the network device at least to receive, from the user device, assistance information for updating the number of measured time instances, the number of predicted time instances, and/or the number of measured and predicted time instances; and apply the number of measured time instances, the number of predicted time instances, and/or the number of measured and predicted time instances.

In an example embodiment of the second aspect, the at least one memory and the computer program code are configured to, with the at least one processor, cause the network device at least to transmit to the user device a confirmation to apply the assistance information in performing reference signal measurements and/or reference signal prediction for the at least one time instance.

In an example embodiment of the second aspect, the at least one memory and the computer program code are configured to, with the at least one processor, cause the network device at least to receive, from the user device, assistance information for updating the number of measured time instances, the number of predicted time instances, and/or the number of measured and predicted time instances; calculate a network device updated number of measured time instances, the number of predicted time instances, and/or the number of measured and predicted time instances based on the assistance information; apply the network device updated number of measured time instances, the number of predicted time instances, and/or the number of measured and predicted time instances; and transmit to the user device an indication to use the network device updated number of measured time instances, the number of predicted time instances, and/or the number of measured and predicted time instances.

According to a third aspect, a method comprises performing both a reference signal measurement and reference signal prediction for at least one time instance for validating the reference signal prediction.

In an example embodiment of the third aspect, the method further comprises receiving, from a network device, an indication to perform both the reference signal measurement and reference signal prediction for the at least one time instance.

In an example embodiment of the third aspect, the method further comprises applying an implicit determination of at least one time instance for which both the reference signal measurement and reference signal prediction is performed, when failing to receive an indication to perform both the reference signal measurement and reference signal prediction for the at least one time instance from a network device.

In an example embodiment of the third aspect, the method further comprises receiving, from a network device, an indication to evaluate whether there is a success or failure of the reference signal prediction for the at least one time instance; determining that there is a success of reference signal prediction for the at least one time instance; and transmitting to the network device a success indication of the reference signal prediction for the at least one time instance.

In an example embodiment of the third aspect, the method further comprises receiving, from the network device, an indication to perform reference signal prediction for the at least one time instance and stop measuring the reference signal for the at least one time instance; and performing reference signal prediction for the at least one time instance and stop measuring the reference signal for the at least one time instance.

In an example embodiment of the third aspect, the method further comprises receiving, from the network device, an indication to perform both reference signal measurement and reference signal prediction for at least one second time instance; and performing both reference signal measurement and reference signal prediction for at least one second time instance.

In an example embodiment of the third aspect, the method further comprises receiving, from the network device, an indication to change the number of time instances that are only predicted, the number of time instances that are only measured and/or the number of time instances that are predicted and measured; and performing reference signal prediction only for the changed the number of time instances that are only predicted and/or reference signal measurements only for the changed the number of time instances that are only measured.

In an example embodiment of the third aspect, the method further comprises receiving, from a network device, an indication to evaluate whether there is a success or failure of the reference signal prediction for the at least one time instance; determining that there is a failure of reference signal prediction for the at least one time instance; and transmitting to the network device a failure indication of the reference signal prediction for the at least one time instance.

In an example embodiment of the third aspect, the method further comprises receiving, from the network device, an indication to maintain performing reference signal prediction for the at least one time instance; and performing reference signal prediction according to the indication.

In an example embodiment of the third aspect, the method further comprises receiving, from the network device, an indication to change the number of time instances that are only predicted, the number of time instances that are only measured and/or the number of time instances that are predicted and measured; and performing reference signal measurements and/or reference signal prediction according to the indication.

In an example embodiment of the third aspect, the method further comprises receiving, from a network device, an indication to report the number of measured time instances, the number of predicted time instances, and/or the number of measured and predicted time instances.

In an example embodiment of the third aspect, the method further comprises determining assistance information for updating the number of measured time instances, the number of predicted time instances, and/or the number of measured and predicted time instances; transmitting, to the network device, the assistance information for updating the number of measured time instances, the number of predicted time instances, and/or the number of measured and predicted time instances; and applying the assistance information in performing reference signal measurements and/or reference signal prediction for the at least one time instance.

In an example embodiment of the third aspect, the method further comprises determining assistance information for updating the number of measured time instances, the number of predicted time instances, and/or the number of measured and predicted time instances; transmitting, to the network device, the assistance information for updating the number of measured time instances, the number of predicted time instances, and/or the number of measured and predicted time instances; receiving, from the network device, a confirmation to apply the assistance information in performing reference signal measurements and/or reference signal prediction for the at least one time instance; and applying the assistance information in performing reference signal measurements and/or reference signal prediction for the at least one time instance.

In an example embodiment of the third aspect, the method further comprises determining assistance information for updating the number of measured time instances, the number of predicted time instances, and/or the number of measured and predicted time instances; and transmitting, to the network device, the assistance information for updating the number of measured time instances, the number of predicted time instances, and/or the number of measured and predicted time instances; receiving, from the network device, an indication to use a network device updated number of measured time instances, number of predicted time instances, and/or number of measured and predicted time instances; and applying the network device updated number of measured time instances, number of predicted time instances, and/or number of measured and predicted time instances.

According to a fourth aspect, a method comprises transmitting an indication to a user device to perform both reference signal measurement and reference signal prediction for at least one time instance for validating the reference signal prediction.

In an example embodiment of the fourth aspect, the method comprises transmitting an indication to the user device to evaluate whether there is a success or failure of the reference signal prediction for the at least one time instance.

In an example embodiment of the fourth aspect, the method comprises receiving, from the user device, a success indication of the reference signal prediction for the at least one time instance; determining, based on the success indication, to perform reference signal prediction for the at least one time instance and stop measuring the reference signal for the at least one time instance; and transmitting an indication to the user device to perform reference signal prediction for the at least one time instance and stop measuring the reference signal for the at least one time instance.

In an example embodiment of the fourth aspect, the method comprises receiving, from the user device, a success indication of the reference signal prediction for the at least one time instance; determining, based on the success indication, to perform both reference signal measurement and reference signal prediction for at least one second time instance; and transmitting an indication to the user device to perform both reference signal measurement and reference signal prediction for at least one second time instance.

In an example embodiment of the fourth aspect, the method comprises receiving, from the user device, a success indication of the reference signal prediction for the at least one time instance; determining, based on the success indication, to change the number of time instances that are only predicted, the number of time instances that are only measured and/or the number of time instances that are predicted and measured; and transmitting an indication to the user device to change the number of time instances that are only predicted and/or change the number of time instances that are only measured.

In an example embodiment of the fourth aspect, the method comprises receiving, from the user device, a failure indication of the reference signal prediction for the at least one time instance; determining, based on the failure indication, to maintain performing reference signal prediction for the at least one time instance; and transmitting an indication to the user device to maintain performing reference signal prediction for the at least one time instance.

In an example embodiment of the fourth aspect, the method comprises receiving, from the user device, a failure indication of the reference signal prediction for the at least one time instance; determining, based on the failure indication, to change the number of time instances that are only predicted, the number of time instances that are only measured and/or the number of time instances that are predicted and measured; and transmitting an indication to the user device to change the number of time instances that are only predicted and/or change the number of time instances that are only measured.

In an example embodiment of the fourth aspect, the method comprises transmitting an indication to the user device to report the number of measured time instances, the number of predicted time instances, and/or the number of measured and predicted time instances.

In an example embodiment of the fourth aspect, the method comprises receiving, from the user device, assistance information for updating the number of measured time instances, the number of predicted time instances, and/or the number of measured and predicted time instances; and applying the number of measured time instances, the number of predicted time instances, and/or the number of measured and predicted time instances.

In an example embodiment of the fourth aspect, the method comprises transmitting to the user device a confirmation to apply the assistance information in performing reference signal measurements and/or reference signal prediction for the at least one time instance.

In an example embodiment of the fourth aspect, the method comprises receiving, from the user device, assistance information for updating the number of measured time instances, the number of predicted time instances, and/or the number of measured and predicted time instances; calculating a network device updated number of measured time instances, the number of predicted time instances, and/or the number of measured and predicted time instances based on the assistance information; applying the network device updated number of measured time instances, the number of predicted time instances, and/or the number of measured and predicted time instances; and transmitting to the user device an indication to use the network device updated number of measured time instances, the number of predicted time instances, and/or the number of measured and predicted time instances.

According to a fifth aspect, there is provided a computer program comprising instructions for causing an apparatus to perform at least the following: performing both a reference signal measurement and reference signal prediction for at least one time instance for validating the reference signal prediction.

According to a sixth aspect, there is provided a computer program comprising instructions for causing an apparatus to perform at least the following: transmitting an indication to a user device to perform both a reference signal measurement and reference signal prediction for at least one time instance for validating the reference signal prediction.

According to a seventh aspect, a user device may comprise means for: performing both a reference signal measurement and reference signal prediction for the at least one time instance for validating the reference signal prediction.

According to an eighth aspect, a network device may comprise means for: transmitting an indication to a user device to perform both a reference signal measurement and reference signal prediction for at least one time instance for validating the reference signal prediction.

According to a ninth aspect, there is provided a non-transitory computer readable medium comprising program instructions for causing an apparatus to perform at least the following: performing both a reference signal measurement and reference signal prediction for the at least one time instance for validating the reference signal prediction.

According to a tenth aspect, there is provided a non-transitory computer readable comprising medium program instructions for causing an apparatus to perform at least the following: transmitting an indication to a user device to perform both a reference signal measurement and reference signal prediction for at least one time instance for validating the reference signal prediction.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates a high-level illustration of beam measurement and prediction in time according to an example embodiment.

FIG. 2 illustrates an example of an apparatus configured to practice one or more example embodiments.

FIG. 3 illustrates an example of an apparatus configured to practice one or more example embodiments.

FIG. 4 illustrates a flow diagram according to an example embodiment.

FIG. 5 illustrates a flow diagram according to another example embodiment.

FIG. 6 illustrates a failure and success event according to an example embodiment.

FIG. 7 illustrates an example of a method according to an example embodiment.

FIG. 8 illustrates an example of a method according to another example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

‘beam’ In the following description, the terms and ‘reference signal’ may be used interchangeably. Further, in the following description, it may be discussed that a user device may perform both a reference signal measurement and reference signal prediction for at least one time instance. These time instances may be called as ‘jointly-measured-predicted’ time instances.

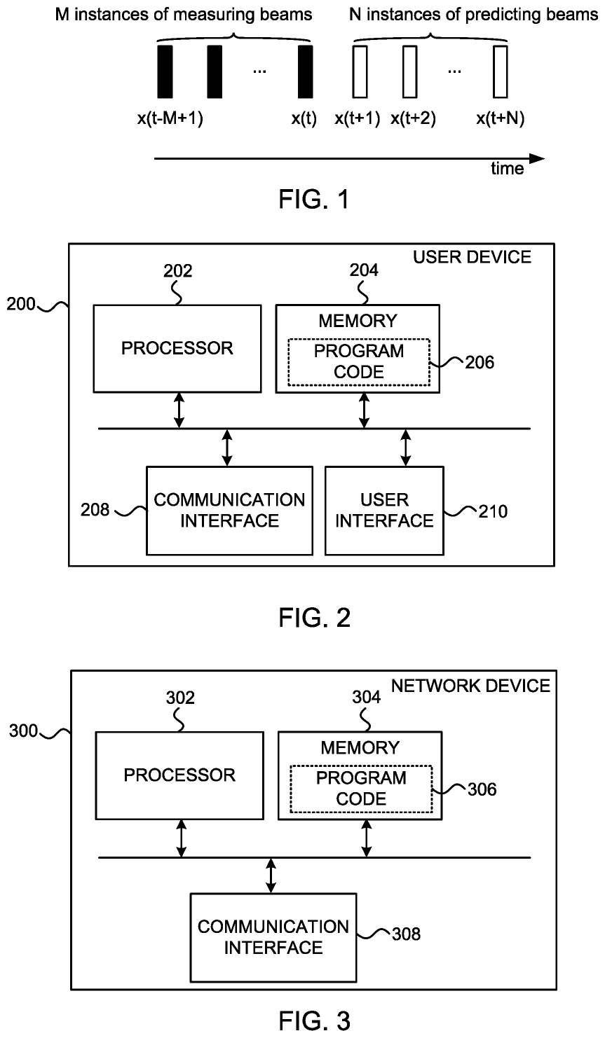

FIG. 1 illustrates a high-level illustration of beam measurement and prediction in time according to an example embodiment.

The beam measurement (for example, Layer 1 Reference Signal Received Power (L1-RSRP)) may comprise measurements for a number of beams (for example, K beams per time instance) for a time period T1, corresponding to M instances at time instances x(t−M+1) . . . x(t). In this context and throughout the description, a beam is understood as a reference signal in a form of a synchronization signal block (SSB), channel state information reference signal (CSI-RS), demodulation reference signal (DMRS) etc.

The beam prediction may comprise predicting the best beams (for example, K1 beams per time instance, K1<K) in the form of best beam ranking with beam indices and/or beam L1-RSRP for a time period T2, corresponding to N instances (or beams if K1=1).

These operations may be repeated in time.

In various example embodiments discussed below, in order to enable beam prediction adaptation in time, one or more time instances from the N time instances may be configured such that both a reference signal measurement and reference signal prediction are performed for the one or more time instances for validating the reference signal prediction. The reference signal prediction may comprise channel state information prediction, for example, in the form of a channel matrix or eigenvectors. The prediction for the at least one instance may be done, for example, based on previously measured at least one instance. Additionally, N and/or M may be enabled to adapt over time. This may allow a decrease in the overhead making it unnecessary to send downlink (DL) reference signals (RS), and perform beam measurement and reporting by the UE in the system.

FIG. 2 illustrates an example of an apparatus configured to practice one or more example embodiments. The apparatus 200 may comprise at least one processor 202. The at least one processor 202 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The at least one memory 204 may be configured to store, for example, computer program code or the like, for example, operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable the apparatus 200 to transmit and/or receive information to/from other devices. In one example, the apparatus 200 may use the communication interface 208 to transmit or receive signaling information and data in accordance with at least one data communication or cellular communication protocol. The communication interface 508 may be configured to provide at least one wireless radio connection, such as, for example, a 3GPP mobile broadband connection (e.g. 3G, 4G, 5G, 6G etc.). In another example embodiment, the communication interface 208 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 508 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The apparatus 200 may further comprise a user interface 210 for user input/output.

When the apparatus 200 is configured to implement some functionality, some component and/or components of the apparatus 200, for example, the at least one processor 202 and/or the at least one memory 204, may be configured to implement this functionality. Furthermore, when the at least one processor 202 configured to is implement some functionality, this functionality may be implemented using the program code 206 comprised, for example, in the at least one memory 204.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 200 may comprise means for performing at least one method described herein. In an example embodiment, the means may comprise the at least one processor 202, the at least one memory 504 including program code 206 configured to, when executed by the at least one processor, cause the apparatus 200 to perform the method.

The apparatus 200 may comprise, for example, a computing device, for example, a mobile device, a mobile phone, a user device, a user equipment, a user node, a tablet computer, a laptop, an internet of things (IoT) device or the like. Examples of IoT devices include, but are not limited to, consumer electronics, wearables, sensors, and smart home appliances. Although the apparatus 200 is illustrated as a single device it is appreciated that, wherever applicable, functions of the apparatus 200 may be distributed to a plurality of devices, for example, to implement example embodiments as a cloud computing service.

An apparatus, for example, a device such as a mobile device, a mobile phone, a user device, a user equipment, a user node, a tablet computer, a laptop, or an internet of things (IoT) device, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

FIG. 3 illustrates an example of an apparatus 300 configured to practice one or more example embodiments. The apparatus 300 may comprise at least one processor 302. The at least one processor 302 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 300 may further comprise at least one memory 304. The at least one memory 304 may be configured to store, for example, computer program code or the like, for example, operating system software and application software. The at least one memory 304 may comprise one or more volatile memory devices, one or more non-volatile memory devices, and/or a combination thereof. For example, the at least one memory 304 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 300 may further comprise a communication interface 308 configured to enable apparatus 300 to transmit and/or receive information to/from other devices. In one example, the apparatus 300 may use the communication interface 308 to transmit or receive signaling information and data in accordance with at least one data communication or cellular communication protocol. The communication interface 308 may be configured to provide at least one wireless radio connection, such as, for example, a 3GPP mobile broadband connection (e.g. 3G, 4G, 5G, 6G etc.). In another example embodiment, the communication interface 308 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 308 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 300 is configured to implement some functionality, some component and/or components of the apparatus 300, for example, the at least one processor 302 and/or the at least one memory 304, may be configured to implement this functionality. Furthermore, when the at least one processor 302 is configured to implement some functionality, this functionality may be implemented using the program code 306 comprised, for example, in the at least one memory 304.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 300 may comprise means for performing at least one method described herein. In an example embodiment, the means may comprise the at least one processor 302, the at least one memory 304 including program code 306 configured to, when executed by the at least one processor, cause the apparatus 300 to perform the method.

The apparatus 300 may comprise, for example, a computing device, for example, a base station, a gNB, a server, a network device, a cloud node or the like. Although the apparatus 300 is illustrated as a single device it is appreciated that, wherever applicable, functions of the apparatus 300 may be distributed to a plurality of devices, for example, to implement example embodiments as a cloud computing service.

An apparatus, for example, a device such as a base station, a gNB, a server, a network device, or a cloud node, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

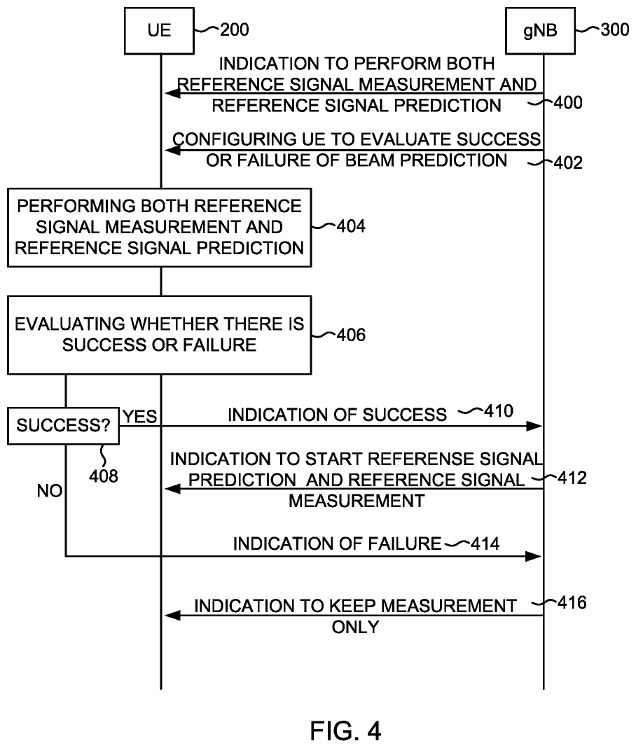

FIG. 4 illustrates a flow diagram according to an example embodiment. A user equipment (UE) 200 may perform reference signal prediction, and the UE 200 may follow a configuration/indication that define a number of measurement instances M (or time duration for measurements) and a number of prediction instances N (or time duration for predictions) illustrated in FIG. 3. The reference signal prediction may comprise beam prediction.

At 400 a base station, for example, a gNB 300 may be configured to transmit an indication to the UE 200 to perform both a reference signal measurement and reference signal prediction for at least one time instance for validating the reference signal prediction. These time instances may be called as “jointly-measured-predicted” time instances.

In an example embodiment, the gNB 300 may send a trigger to the UE 200, and the UE 200 may then consider all instances within a configured or indicated time period as jointly-measured-predicted instances. In another example embodiment, the gNB 300 may indicate the UE 200 that jointly-measured-predicted instances are periodic/recurrent in time. Additionally, or alternatively, the periodic/recurrent instances may only be valid for certain period of time (for example, considering an expiration of a configured timer). In another example embodiment, the gNB 300 may indicate the UE 200 the first time instance, and the UE 200 may assume that all the subsequently measured (or predicted) instances are jointly-measured-predicted time instances. The gNB 300 may send another indication to the UE 200 to indicate the UE the last jointly-measured-predicted instance or to stop jointly-measured-predicted instances. In another example embodiment, the gNB 300 may indicate the UE 200 to measure time instances which overlap in time (or which belong to a same slot/sub-slot or period of time) with the prediction instances. The UE 200 may then assume those instances as jointly-measured-predicted instances. In another example embodiment, the gNB 300 may explicitly indicate to the UE 200 which time instances the UE 200 should consider as jointly-measured-predicted instances.

In an example embodiment, a channel state information references signal (CSI-RS) resource or a resource set may be configured or indicated, for example, via downlink control information (DCI) or medium access control control element (MAC CE), using some existing or reserved bits or new bits or fields, to be jointly-measured-predicted. Hence, by activating or triggering this CSI-RS, the UE 200 may understand that both beam measurement and beam prediction should be performed for the corresponding time instance(s). In another example embodiment, a CSI-RS resource or a resource set may be configured or indicated, for example, via DCI or MAC CE, using some existing or reserved bits or new bits or fields, to be measured only or to define a predicted only instance. In another embodiment, there may be indication, for example as part of the CSI-RS triggering in DCI or MAC CE, of the number of or the time duration corresponding to the jointly measured-predicted instances or to the predicted-only instances.

In another example embodiment, the UE 200 may receive from the gNB 300 an indication to change the number of time instances that are only predicted, the number of time instances that are only measured and/or the number of time instances that are predicted and measured. Then, later at 404, the UE 200 may perform measurement only on at least one second time instance and/or prediction only on at least one third time instance.

In another example embodiment, the UE 200 may receive from the gNB 300 an indication to change the number of time instances that are only predicted, the number of time instances that are only measured and/or the number of time instances that are predicted and measured. Then, later at 404, the UE 200 may perform reference signal prediction only for the changed the number of time instances that are only predicted and/or reference signal measurements only for the changed the number of time instances that are only measured.

In another example embodiment, the UE 200 may not receive an explicit indication from the gNB 300 as discussed at step 400. When a configuration or indication associated with the jointly-measured-predicted instances is not received at the UE 200, the UE 200 may apply an implicit determination of at least one jointly-measured-predicted instance, wherein the jointly-measured-predicted instance can be the at least the first measurement instance of the next set of measurement instances (corresponding to N+1 prediction instance of the previous set of prediction instances, wherein only N prediction instances are configured to the UE).

At 402 the gNB 300 may be configured to configure the UE 200 to evaluate beam prediction success or failure for the at least one time instance. In another example embodiment, the gNB 300 may not necessarily send an explicit indication to the UE 200, and the UE 200 can perform the evaluation over time without necessarily receiving an explicit indication from the gNB 300.

At 404 the UE 200 may perform both a reference signal measurement and reference signal prediction for the at least one time instance. The prediction for the at least one instance may be done, for example, based on previously measured at least one instance.

At 406 the UE 200 may be configured to evaluate whether there is a success or failure of the reference signal prediction for the at least one time instance based on the configuration at step 402.

The success or failure of the reference signal prediction may be evaluated, for example, by counting the number of or ‘success’ events and comparing that to a predefined configured threshold, or counting the number of ‘failure’ events and comparing that to a predefined or configured threshold, considering a time window including jointly-measured-predicted time instances or considering a number of jointly-measured-predicted instances. In another example embodiment, the ‘success’ (or ‘failure’) rate may be calculated by dividing the number of ‘success’ event (or ‘failure’ events) by the number of jointly-measured-predicted time instances. This rate may then be compared to a preconfigured threshold to decide whether there is a ‘success’ or ‘failure’ event. In another example embodiment, the ‘success’ of reference signal prediction for one instance (at one time) may mean that the difference between predicted and measured RSRP values for the best beam (or any RSRP of a number of best beams, or any other measurements) is below a configured threshold; otherwise, there is ‘failure’ of reference signal prediction for that instance (at that time).

A success of reference signal prediction for one instance (at one time) may mean that the predicted beam(s) is having a good representation (or similar) of the measured best beam(s), or is among a number of best beams, based on measurements corresponding to this instance. Otherwise, it may be determined that there is failure of beam prediction for that instance (at that time).

If the result at step 408 is ‘success’, the UE 200 may be configured to send to the gNB 300 at 410 an indication or a report to indicate the success. At 412 the gNB 300 may be configured to send to the UE 200 an indication to start reference signal prediction only for the at least one time instance (and thus stop measurement of the at least one time and reference signal prediction instance) joint and measurements for at least one second time instance. In another example embodiment, the gNB 300 may be configured to send to the UE 200 only the indication to start reference signal prediction only for the at least one time instance (and thus stop measurement of the at least one time instance).

In another example embodiment, at 412 the gNB 300 may be configured to decrease (or increase) the number of measured-only time instances, i.e. M, and/or increase (or decrease) the number of predicted-only instances, i.e. N.

If the result at step 408 is ‘failure’, the UE 200 may be configured to send to the gNB 300 at 414 an indication or a report to indicate the failure of reference signal prediction for the at least one time instance. In response to the failure indication, the gNB 300 may be configured to indicate to the UE 200 to keep only measurement for the at least one time instance. This may entail updating M and/or N also. In another example embodiment, at 416 the gNB 300 may be configured to indicate to the UE 200 to keep (or stop) performing reference signal prediction for the at least one time instance. In another example embodiment, at 416 the gNB 300 may be configured to decrease (or keep the same) the number of predicted-only instances, i.e. N, and/or increase (or decrease) the number of measured-only time instances, i.e. M.

In order to report the reference signal prediction success or failure event to the gNB 300, the UE 200 may use dedicated or shared uplink resources, for example, physical uplink control channel (PUCCH) or physical uplink shared channel (PUSCH) resources (using uplink control information (UCI) or MAC CE). In an example embodiment, at least one PUCCH resource (and its corresponding configuration), to be used for the reporting, may be configured to be (only) available:
after a certain offset (for example, in number of slots/sub-slots or symbols) from the slot or from the last (or first) orthogonal frequency-division multiplexing (OFDM) symbol corresponding to the CSI-RS (or SSB) or corresponding to the at least one instance for which both measurement and prediction is applied, and
after or once a timer, for evaluating whether there is success or failure, expires.

In another example embodiment, a periodic PUCCH resource(s) may be configured and used by the UE 200 for such an indication, for example, using PUCCH format 0/1. The bit ‘0’ may be used to indicate a beam prediction failure whereas the bit ‘1’ may be used to indicate a beam prediction success.

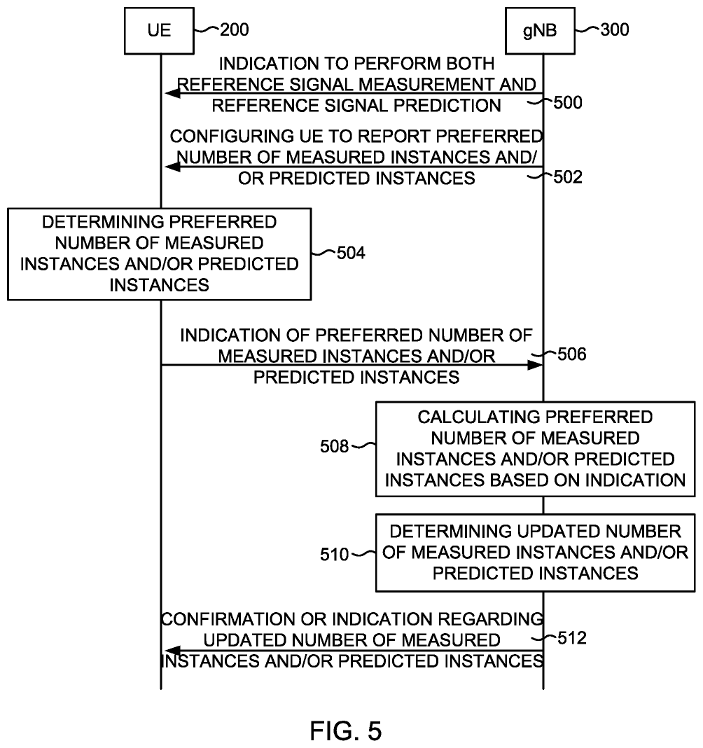

FIG. 5 illustrates a flow diagram according to another example embodiment. FIG. 5 illustrates a high-level flow diagram providing an example embodiment in which the UE 200 provides an indication on a preferred number of instances to measure and/or preferred number of instances to predict.

At 500 the gNB 300 may be configured to transmit an indication to the UE 200 to perform both a reference signal measurement and reference signal prediction for at least one time instance for validating the reference signal prediction. These time instances may be called as “jointly-measured-predicted” time instances. The reference signal prediction may comprise beam prediction.

At 502 the gNB 300 may be configured to configure the UE 200 to report a preferred number of measured time instances and/or predicted time instances.

At 504 the UE 200 may be configured to determine the preferred number of measured time instances and/or predicted time instances. In an example embodiment, the determination of the preferred number of measured time instances and/or predicted time instance may be UE implementation specific. In another example embodiment, it is possible to at least partially rely on similar success/failure evaluation operation (at the UE 200) defined for the other embodiment discussed in relation to FIG. 4. In this case, the UE 200 may not necessarily report the success/failure event, but a preferred M, N, and/or number of jointly-measured-predicted instances.

At 506 the UE 200 may be configured to send an indication of the preferred number of measured time instances and/or predicted time instances to the gNB 300. This may entail an introduction of a new uplink control information (UCI) type, which can be reported on PUCCH and/or PUSCH.

At 508 the gNB 300 may be configured to calculate the (new) preferred number of measured time instances and/or predicted time instances based on the indicated obtained from the UE 200.

At 510 the gNB 300 may be configured to determine an updated number of measured time instances and/or an updated number of predicted time instances. In an example embodiment, the gNB 300 may not necessarily select the same numbers calculated at 508.

At 512 the gNB 300 may be configured to transmit a confirmation or an indication of the updated number of measured time instances and/or an updated number of predicted time instances to the UE 200.

In an example embodiment, at 506 the UE 200 may be configured to report to the gNB 300 at least one integer value (which can be non-negative value or negative value), from a configured set of values, for updating M, N, and/or the number of jointly-measured-predicted time instances.

In an example embodiment, the UE 200 and the gNB 300 may directly update M, N, and/or the number of jointly-measured-predicted instances based on the information provided by the UE 200. Alternatively, the UE 200 may need to wait for an indication or confirmation from the gNB 300 regarding the updated M, N, and/or number of jointly-measured-predicted instances, as indicated at 512.

In an example embodiment, the UE 200 may indicate a value ‘+1’ to the gNB 300 for updating M, and the UE 200 and gNB 300 may update M by setting the new M as the old M+1. This can be understood as providing an additional reference signal to be used for the measurement. Alternatively, the UE 200 may indicate a value ‘−1’ to the gNB 300 for updating M, and the UE 200 and gNB 300 may update M by setting the new M as the old M−1. This can be understood as providing one less reference signal to be used for the measurement.

In another example embodiment, the UE 200 may indicate a value ‘+2’ to the gNB 300 for updating N, and the UE 200 and gNB 300 may update N by setting the new N as the old N+2. This can be understood as increasing the prediction window length with two prediction occasions/instances and this may happen in conjunction with a success event at the UE 200. Alternatively, the UE 200 may indicate a value ‘−1’ to the gNB 300 for updating N, and the UE 200 and gNB 300 may update N by setting the new N as the old N−1. This can be understood as reducing the prediction window with one prediction opportunity. The increasing and decreasing of the prediction windows may happen with different sizes of the prediction steps where an increase in the prediction window may be typically longer than a decrease of a prediction window.

In any of the example embodiments discussed above relating to any of FIGS. 1-5, K and/or K1 may be adapted over time by considering M equals to or greater than one and/or N equals to or greater than one. For example, if M=1 and N=1, the number of ‘measured instances’ may refer to K and the number of ‘predicted instances’ may refer to K1. Then, all the described operations on how to evaluate a prediction failure and/or how to adapt M, N, and or a number of jointly measured-predicted instances may be applied by replacing M by K and N by K1. It is noted that in this case an ‘instance’ may not necessarily be a time instance. As another example, the adaption of K and K1 may be done in addition to the adaptation of M and/or N. This may be seen as spatial-temporal or spatial domain beam prediction adaptation.

In any of the example embodiments discussed above relating to any of FIGS. 1-5, a jointly-measured-predicted instance may be represented using a CSI-RS resource or resource set. More generally, any predicted-only or measured-only instance may be represented using a CSI-RS or resource set. Further, there may be indication (in RRC, MAC CE or DCI) whether a given CSI-RS resource or resource set corresponds to a reference signal measurement instance or reference signal prediction instance or jointly-measured-predicted instance.

In any of the example embodiments discussed above relating to any of FIGS. 1-5, the indication of an update of M, N, and/or the number of jointly measured-predicted instances may be done by using a bit-field in DCI and/or MAC CE. Alternatively, an incremental/decremental step (or delta) could be indicated (in DCI and/or MAC CE) to update M or N. Alternatively, a bitmap may be used to indicate the updated N or M.

In any of the example embodiments discussed above relating to any of FIGS. 1-5, M and N may be paired, and thus the gNB 300 may indicate/update the pair {M, N} using at least one indication or codepoint. For example, up to a certain number of {M, N} pairs may be activated or indicated via MAC CE or radio resource control (RRC), and the UE 200 may be indicated (for example, via DCI or MAC CE) suitable pair determined by the gNB 300 based at least partially on the UE 200 reporting of success/failure event(s).

In any of the example embodiments discussed above relating to any of FIGS. 1-5, the number of jointly measured-predicted instances may be counted as part of M or N.

In any of the example embodiments discussed above relating to any of FIGS. 1-5, the sum of M and N, i.e. M+N, may be fixed by the gNB 300. An increase of N may automatically lead to a decrease of M and vice versa, and an increase of M may automatically lead to a decrease of N and vice versa. In an example embodiment, there may be an indication whether the gNB 300 is indicating M or N (or an incremental/decremental step for M or N). Based on this indication and the indication of the update on M/N, the UE 200 may deduce the change/update for N/M.

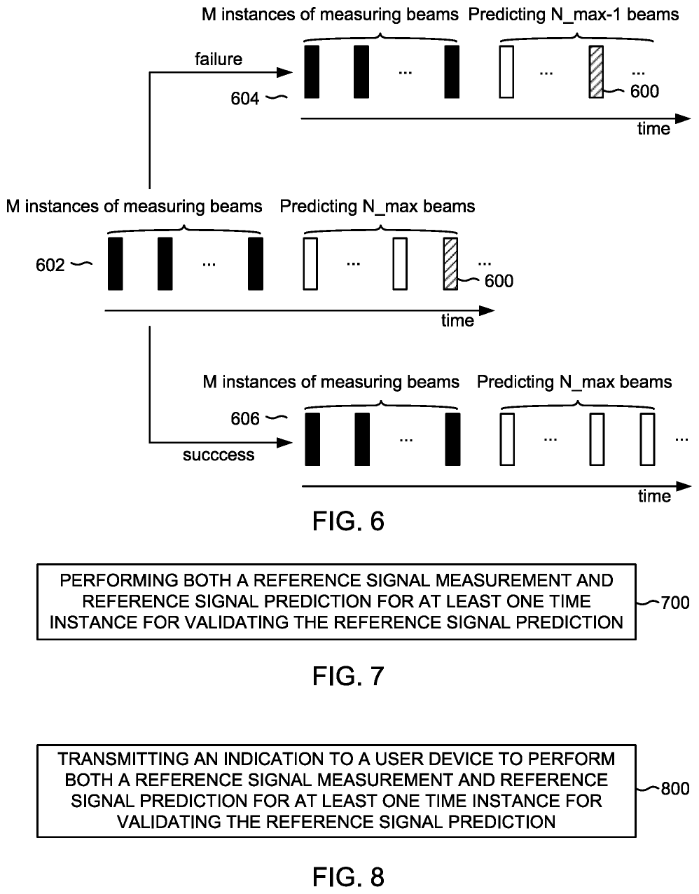

FIG. 6 illustrates a failure and success event according to an example embodiment.

The gNB 300 may start at 602 with a prediction mode with N=N_max predicted instances/beams, where N_max may be the largest number of instances for which beam prediction is used. A time instance 600 is a jointly-measured-predicted time instance. The gNB 300 may ask the UE 200 to also perform beam measurement for the N-th instance over a period of time or for a given number of times. This can be triggered by the gNB 300 by using a MAC CE or DCI indication (or even RRC signaling) to the UE 200. In an example embodiment, a timer may be configured (for example, via RRC) and it can be maintained (for example, in MAC layer) for the purpose of defining the time period over which this operation should be performed.

The UE 200 may be configured to determine and/or report whether there is ‘success’ or ‘failure’ of the beam prediction for the N-th instance.

If there is ‘success’, at 606 the UE 200 may report this event to the gNB 300, for example, by using dedicated or shared UL resources, for example, PUCCH/PUSCH resources (using UCI or MAC CE). The gNB 300 may indicate the UE 200 to keep the prediction for N=N_max. The gNB 300 may (or may not) indicate the UE 200 to stop measurement for the N-th instance.

If there is ‘failure’, at 604 the UE 200 may report the failure event to the gNB 300, for example, by g. using dedicated or shared UL resources, for example, PUCCH/PUSCH resources (using UCI or MAC CE). The gNB 300 may indicate the UE 200 to stop beam prediction for the N-th instance and perform prediction for N_max−1. The gNB 300 may also ask the UE 20 to perform beam measurements for the N-th instance, where N=N_max−1.

FIG. 7 illustrates an example of a method according to an example embodiment.

At 700 a user device, for example, a UE, may be configured to perform both a reference signal measurement and reference signal prediction for at least one time instance. When both the reference signal measurement and reference signal prediction are performed for the at least one time instance, it may enable validating the reference signal prediction. The prediction for the at least one instance may be done, for example, based on previously measured at least one instance.

FIG. 8 illustrates an example of a method according to another example embodiment.

At 800 a network device, for example, a gNB, may be configured to transmit an indication to a user device to perform both a reference signal measurement and reference signal prediction for at least one time instance. When both the reference signal measurement and reference signal prediction are performed for the at least one time instance, it may enable validating the reference signal prediction.

One or more of the above discussed examples and embodiments may enable a solution for maintaining a good beam prediction operation and adapting it with time. One or more of the above discussed examples and embodiments may enable a solution for dynamic adaption of the measured instances, predicted instances, and/or jointly measured-predicted instances. One or more of the above discussed examples and embodiments may enable a solution for guaranteeing some levels of throughput and robustness/reliability in wireless communication system while exploiting the benefits of beam prediction (such as lower overhead at the UE and/or gNB side).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and such as software, (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-22. (canceled)

23. A user device, comprising:
at least one processor; and at least one memory, the at least one memory storing instructions, that when executed by the at least one processor, cause the user device at least to:
perform both a reference signal measurement and reference signal prediction for at least one time instance for validating the reference signal prediction.

24. The user device according to claim 23, wherein the instructions, when executed by the at least one processor, further cause the user device at least to:
receive, from a network device, an indication to perform both the reference signal measurement and reference signal prediction for the at least one time instance.

25. The user device according to claim 23, wherein the instructions, when executed by the at least one processor, further cause the user device at least to:
determine that there is a success of reference signal prediction for the at least one time instance; and
transmit to the network device a success indication of the reference signal prediction for the at least one time instance.

26. The user device according to claim 25, wherein the instructions, when executed by the at least one processor, further cause the user device at least to:
receive, from the network device, an indication to perform reference signal prediction for the at least one time instance and stop measuring the reference signal for the at least one time instance; and
perform reference signal prediction for the at least one time instance and stop measuring the reference signal for the at least one time instance.

27. The user device according to claim 25, wherein the instructions, when executed by the at least one processor, further cause the user device at least to:
receive, from the network device, an indication to perform both reference signal measurement and reference signal prediction for at least one second time instance; and
perform both reference signal measurement and reference signal prediction for at least one second time instance.

28. The user device according to claim 23, wherein the instructions, when executed by the at least one processor, further cause the user device at least to:
determine that there is a failure of reference signal prediction for the at least one time instance; and
transmit to the network device a failure indication of the reference signal prediction for the at least one time instance.

29. The user device according to claim 28, wherein the instructions, when executed by the at least one processor, further cause the user device at least to:
receive, from the network device, an indication to maintain performing reference signal prediction for the at least one time instance; and
perform reference signal prediction according to the indication.

30. The user device according to claim 23, wherein the instructions, when executed by the at least one processor, further cause the user device at least to:
receive, from a network device, an indication to report the number of measured time instances, the number of predicted time instances, and/or the number of measured and predicted time instances.

31. The user device according to claim 30, wherein the instructions, when executed by the at least one processor, further cause the user device at least to:
determine assistance information for updating the number of measured time instances, the number of predicted time instances, and/or the number of measured and predicted time instances;
transmit, to the network device, the assistance information for updating the number of measured time instances, the number of predicted time instances, and/or the number of measured and predicted time instances; and
apply the assistance information in performing reference signal measurements and/or reference signal prediction for the at least one time instance.

32. The user device according to claim 30, wherein the instructions, when executed by the at least one processor, further cause the user device at least to:
determine assistance information for updating the number of measured time instances, the number of predicted time instances, and/or the number of measured and predicted time instances;
transmit, to the network device, the assistance information for updating the number of measured time instances, the number of predicted time instances, and/or the number of measured and predicted time instances;
receive, from the network device, a confirmation to apply the assistance information in performing reference signal measurements and/or reference signal prediction for the at least one time instance; and
apply the assistance information in performing reference signal measurements and/or reference signal prediction for the at least one time instance.

33. The user device according to claim 32, wherein the instructions, when executed by the at least one processor, further cause the user device at least to:
determine assistance information for updating the number of measured time instances, the number of predicted time instances, and/or the number of measured and predicted time instances;
transmit, to the network device, the assistance information for updating the number of measured time instances, the number of predicted time instances, and/or the number of measured and predicted time instances;
receive, from the network device, an indication to use a network device updated number of measured time instances, number of predicted time instances, and/or number of measured and predicted time instances; and
apply the network device updated number of measured time instances, number of predicted time instances, and/or number of measured and predicted time instances.

34. A network device, comprising:
at least one processor; and at least one memory, the at least one memory storing instructions, that when executed by the at least one processor, cause the network device at least to:
transmit an indication to a user device to perform both a reference signal measurement and reference signal prediction for at least one time instance for validating the reference signal prediction.

35. The network device according to claim 34, wherein the instructions, when executed by the at least one processor, further cause the network device at least to:
transmit an indication to the user device to evaluate whether there is a success or failure of the reference signal prediction for the at least one time instance.

36. The network device according to claim 35, wherein the instructions, when executed by the at least one processor, further cause the network device at least to:
receive, from the user device, a success indication of the reference signal prediction for the at least one time instance;
determine, based on the success indication, to perform reference signal prediction for the at least one time instance and stop measuring the reference signal for the at least one time instance; and
transmit an indication to the user device to perform reference signal prediction for the at least one time instance and stop measuring the reference signal for the at least one time instance.

37. The network device according to claim 35, wherein the instructions, when executed by the at least one processor, further cause the network device at least to:
receive, from the user device, a success indication of the reference signal prediction for the at least one time instance;
determine, based on the success indication, to perform both reference signal measurement and reference signal prediction for at least one second time instance; and
transmit an indication to the user device to perform both reference signal measurement and reference signal prediction for at least one second time instance.

38. The network device according to claim 34, wherein the instructions, when executed by the at least one processor, further cause the network device at least to:
receive, from the user device, a failure indication of the reference signal prediction for the at least one time instance;
determine, based on the failure indication, to maintain performing reference signal prediction for the at least one time instance; and
transmit an indication to the user device to maintain performing reference signal prediction for the at least one time instance.

39. The network device according to claim 34, wherein the instructions, when executed by the at least one processor, further cause the network device at least to:
transmit an indication to the user device to report the number of measured time instances, the number of predicted time instances, and/or the number of measured and predicted time instances.

40. The network device according to claim 39, wherein the instructions, when executed by the at least one processor, further cause the network device at least to:
receive, from the user device, assistance information for updating the number of measured time instances, the number of predicted time instances, and/or the number of measured and predicted time instances; and
apply the number of measured time instances, the number of predicted time instances, and/or the number of measured and predicted time instances.

41. The network device according to claim 40, wherein the instructions, when executed by the at least one processor, further cause the network device at least to:
transmit to the user device a confirmation to apply the assistance information in performing reference signal measurements and/or reference signal prediction for the at least one time instance.

42. A method, comprising:
performing, by a user device, both a reference signal measurement and reference signal prediction for at least one time instance for validating the reference signal prediction.
